(19) United States
(12) Patent Application Publication
(10) Pub. No.: US 2019/0040217 A1
(43) Pub. Date: Feb. 7, 2019

(54) PLA Pellets Enhanced with Calcium Carbonate from Powdered Zebra Mussel Shells and Quagga Mussel Shells

(71) Applicant: Lorena James, Buffalo, NY (US)

(72) Inventor: Lorena James, Buffalo, NY (US)

(21) Appl. No.: 16/055,812

(22) Filed: Aug. 6, 2018

Related U.S. Application Data
(60) Provisional application No. 62/541,296, filed on Aug. 4, 2017.

(51) Int. Cl. C08J 7/06

(52) U.S. Cl. CPC C08J 7/06; B33Y 70/00; C08J 2367/04

(57) ABSTRACT

Provided are materials for 3D printing. The materials have calcium carbonate and polylactic acid. The calcium carbonate is derived from natural sources, such as the shells of zebra mussels or quagga mussels. The calcium carbonate can coat a pellet of polylactic acid. Also disclosed are methods of making and using the same.

### CROSS-REFERENCE TO RELATED APPLICATIONS

This application claims priority to U.S. Provisional Application No. 62/541,296, filed on Aug. 4, 2017, the disclosure of which is hereby incorporated by reference.

### FIELD OF THE DISCLOSURE

The invention relates to polylactic acid (PLA) pellets used for producing 3D printing filament and additives for the same.

### BACKGROUND OF THE DISCLOSURE

Invasive species are an immense problem in the Lake Erie region to both human and wildlife populations. For example, zebra mussels and quagga mussels can clog boat pipes and engines, water intake pipes of water treatment plants, and pipes of power plants. Zebra mussels and quagga mussels also can contribute to algae blooms. The shells of zebra mussels and quagga mussels make beaches foul and dangerous. Parks may have to close their swimming beach and picnic areas due to high volumes of zebra mussel shells and quagga mussel shells on their shoreline. For example, Crane Creek Park in Ohio had its swimming beach and picnic areas closed due to high volumes of zebra mussel shells and quagga mussel shells on its shoreline. Besides smelling foul and spreading bacteria on the beach, the shells are sharp and can injure beachgoers.

Zebra mussels and quagga mussels lack many natural predators in North America. In fact, zebra mussels and quagga mussels are thought to carry diseases that can kill birds. Human consumption of zebra mussels and quagga mussels is not recommended because these organisms tend to accumulate pollutants, microorganisms, and toxins.

Consequently, industrial uses for zebra mussels and quagga mussels are being sought.

### BRIEF SUMMARY OF THE DISCLOSURE

The present disclosure describes materials comprising zebra shell powder and PLA pellets. Compositions and methods are described herein.

An embodiment of the present disclosure may provide a material for 3D printing, comprising CaCO₃ and polylactic acid, wherein the CaCO₃ is derived from crushed zebra mussel shells and/or crushed quagga mussel shells.

According to an embodiment of the present disclosure, CaCO₃ and polylactic acid may be present in the material in a ratio of 1:3 of CaCO₃ to polylactic acid.

According to another embodiment of the present disclosure, CaCO₃ and polylactic acid may be present in the material in a ratio of 1:4 of CaCO₃ to polylactic acid.

According to another embodiment of the present disclosure, CaCO₃ and polylactic acid may be present in the material in a ratio of 1:5 of CaCO₃ to polylactic acid.

According to an embodiment of the present disclosure, the CaCO₃ in the material may be primarily calcite.

According to another embodiment of the present disclosure, the CaCO₃ in the material may be only calcite.

According to an embodiment of the present disclosure, a grain size of the CaCO₃ may be less than or equal to 125 microns.

According to another embodiment of the present disclosure, a grain size of the CaCO₃ may be less than or equal to 63 microns.

An embodiment of the present disclosure may provide a method of preparing a 3D printing material, comprising: i) combining calcium carbonate and polylactic acid to form a mixture, wherein the calcium carbonate is derived from crushed zebra mussel shells and/or crushed quagga mussel shells; and ii) heating the mixture.

According to an embodiment of the present disclosure, the polylactic acid may be a plurality of polylactic acid pellets.

According to an embodiment of the present disclosure, the mixture may be heated to a temperature of 155 to 165° C.

According to an embodiment of the present disclosure, the method may further comprise passing the heated mixture through an extruder.

### DESCRIPTION OF THE DRAWINGS

For a fuller understanding of the nature and objects of the disclosure, reference should be made to the following detailed description taken in conjunction with the accompanying drawings.

FIG. 1 is an illustration of a single PLA pellet (magnified).

FIG. 2 is an illustration of a single PLA pellet coated with zebra mussel shell and quagga mussel shell powder composite (magnified).

FIG. 3 is an image of pH test completed with powdered zebra mussel shell and powdered quagga mussel shell sample.

FIG. 4 is an image of zebra mussel shells and quagga mussel shells collected from a beach.

FIG. 5 is an image of pure PLA pellets.

FIG. 6 is an image of melted pure PLA pellets.

FIG. 7 is an image of PLA pellets coated with CaCO₃.

FIG. 8 is an image of melted PLA pellets coated with 0.45 g CaCO₃.

FIG. 9 is an image of PLA pellets with 2 g of CaCO₃.

FIG. 10 is an image of melted PLA pellets with 2 g of CaCO₃.

FIG. 11 is an image of beakers filled with PLA pellets and various amounts of CaCO₃.

FIG. 12 is a table with the results of an experiment.

FIG. 13 is an image of a spool of the 3D printing filament of the present disclosure.

FIG. 14 is a flowchart of an exemplary method of producing the 3D printing filament of the present disclosure.

### DETAILED DESCRIPTION

Although subject matter herein will be described in terms of certain embodiments, other embodiments, including embodiments that do not provide all of the benefits and features set forth herein, are also within the scope of this disclosure. Various structural and process step changes may be made without departing from the scope of the disclosure.

Objects of various shapes can be manufactured by additive manufacturing methods that can be referred to as 3D printing. 3D printing manufactures objects by placing successive layers of material on themselves to form the final printed object. PLA is used for 3D printing because it is biocompatible and easy to work with.

When 3D printing with PLA, the resulting object is somewhat transparent compared to acrylonitrile butadiene styrene (ABS) plastics. However, adding calcium carbonate (CaCO₃) to PLA makes the plastic less transparent, which can be beneficial when 3D printing certain objects. For example, lampshades or other objects that block light can benefit from less transparent plastic.

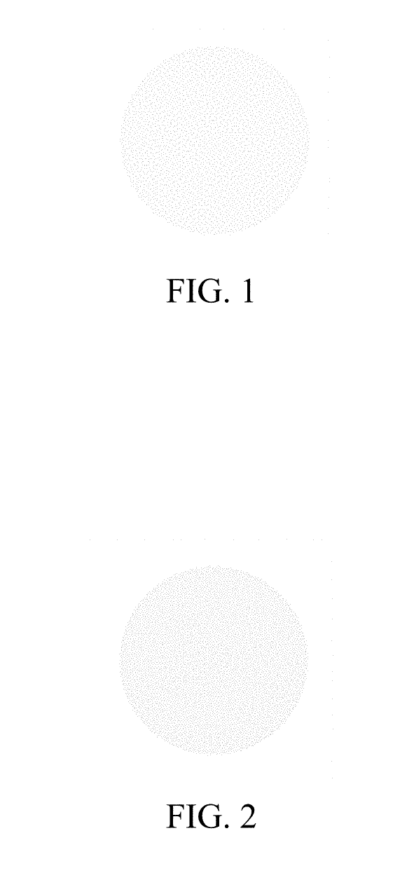

Zebra mussel shells and quagga mussel shells are a natural source of calcium carbonate. By coating PLA pellets with the zebra mussel shell and quagga mussel shell powder, the PLA pellets becomes more opaque. This can be seen in FIGS. 1 and 2. FIG. 2 is darker and less opaque than FIG. 1.

Zebra mussel shells and quagga mussel shells are found in places such as, but not limited to, the Great Lakes, Nevada, and California. The shells can be collected off beaches in the aforementioned areas. The powdered shells can be obtained through any grinding and/or crushing method.

The resulting material for 3D printing can include CaCO₃ and PLA. The CaCO₃ is derived from crushed zebra mussel shells and/or crushed quagga mussel shells. The CaCO₃ and the polylactic acid may be present in a ratio of CaCO₃ to polylactic acid from 1:3 to 1:33. For example, the CaCO₃ and the polylactic acid may be present in a ratio of 1:3, 1:4, or 1:5. Other ratios are possible.

In one embodiment, the ratio is one part shell powder (CaCO₃) to three part PLA. When more calcium carbonate added to the 1:3 ratio, the 3D printer may clog more frequently or at a faster rate. A 3D printer may clog when switching between filaments (i.e., switching between PLA and ABS filaments), but minimizing clogs increases throughput. The ratio of one part shell powder to 33 parts PLA may be the lowest possible amount of shell powder that can be used to see a significant visual difference between standard PLA filament and PLA with shell powder filament. However, lower ratios of shell powder to PLA may be used for certain applications.

The particle size of the PLA mixed with the powdered shells may be less than the size of the nozzle used during 3D printing. Steel-based nozzles or other abrasive-resistant materials may be used in the 3D printer. In an instance, the 3D printer has a nozzle diameter of 1.0 mm or less. Smaller nozzles are possible and can successfully print objects, but also may increase the risk of clogging or obstruction.

The grain size of the powdered shell may be less than or equal to 125 microns. For example, the grain size of the powdered shell may be less than or equal to approximately 63 microns. A grain size less than or equal to 63 microns can avoid clogging both of the filament extruder nozzle and the 3D printer nozzle.

Other shell powders can replace zebra mussel shell powder and quagga mussel shell powder. 3D printing filament pellets besides PLA may be coated with the powdered shell composites to produce a biodegradable 3D printing filament.

By coating PLA pellets with a zebra mussel shell powder and quagga mussel shell powder composite, beach environments in areas affected by these invasive species (zebra mussels and quagga mussels) are improved. By providing a manufacturing purpose for these shells, there now exists an improved rationale to remove such shells from affected beaches. The PLA pellet with zebra mussel shell powder and/or quagga mussel shell powder composite can be extruded with a 3D printing filament extruder to make 3D printing filament. The resulting product serves as an alternative 3D printing filament that is both biodegradable and less translucent than standard PLA. This 3D printing filament can be used in industries such as, but not limited to, architecture, consumer goods, technology, and commercial products.

Using calcium carbonate from zebra and quagga mussel shell powder in these embodiments can provide incentive to remove shells from beaches and can spread awareness of the issues caused by these invasive shell species. In addition, calcium carbonate sourced from these shells is more environmentally-friendly than ground limestone because the charges used to mine limestone result in noise pollution, dust pollution, sinkholes, and decreased quality of underground water aquifers. Sourcing calcium carbonate from zebra and quagga mussel shells eliminates these drawbacks.

Using calcium carbonate from zebra and quagga mussel shell powder provides advantages compared to other sources of calcium carbonate. Shell powder from zebra and quagga mussel shells primarily includes or only includes calcite. Other sources of calcium carbonate can include other crystal structures of calcium carbonate, other materials, or impurities. For example, ground limestone includes calcite and aragonite. Calcite and aragonite have different hardness and dissolution properties, which can affect application of the shell powder to PLA, printing results, or properties of resulting shell powder particles.

The shells of zebra and quagga mussels naturally vary in color from shades of light to dark brown. When pulverized, the powdered shells take on the appearance of a light tan nearing white similar to ground limestone. However, this shade of light tan can vary with the overall age of the shells. The longer the shells sit out in the sun on a beach, the lighter the shells become. Thus, the difference in color may vary depending on the age of the shells. The color of the shells can affect the resulting printed object or shell-coated PLA.

The amount of CaCO₃ in or on PLA can vary with, for example, the makeup, surface properties, melting point, or other mechanical properties of the PLA. Thus, the optimal amount of CaCO₃ in or on the PLA may be different from the experimental results disclosed herein.

Generally, the more calcium carbonate mixed with PLA, the rougher the surface of the filament and the more brittle the filament may become. These properties can be beneficial because the more brittle the filament, the faster it decomposes. This does not necessarily mean that the filament is too brittle to handle or use as a PLA filament for 3D printing.

PLA colorant additives also can be added. In 3D printing, PLA colorant additives can be used to apply colors such as black, red, green, yellow, or purple. Such colorant additives may be mixed with PLA pellets to be extruded, coloring the resulting filament.

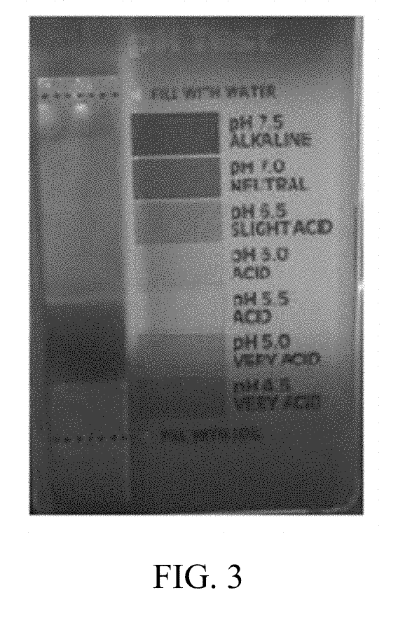

According to FIG. 3, the powdered zebra mussel shells and powdered quagga mussel shells will have a neutral pH value (7). Shells collected from different regions or lakes may have different pH values.

The following examples are presented to illustrate the present disclosure. They are not intended to limiting in any matter.

In the examples disclosed herein, a Monoprice MP Select Mini 3D Printer V2 was used for printing, but any 3D printer can be used. For example, printers from MakerBot, MatterHackers, Formlabs, or others may be used.

In the examples disclosed herein, PLA pellets and pulverized PLA from Filabot are used. PLA from any other manufacturers also can be used.

### EXAMPLE 1

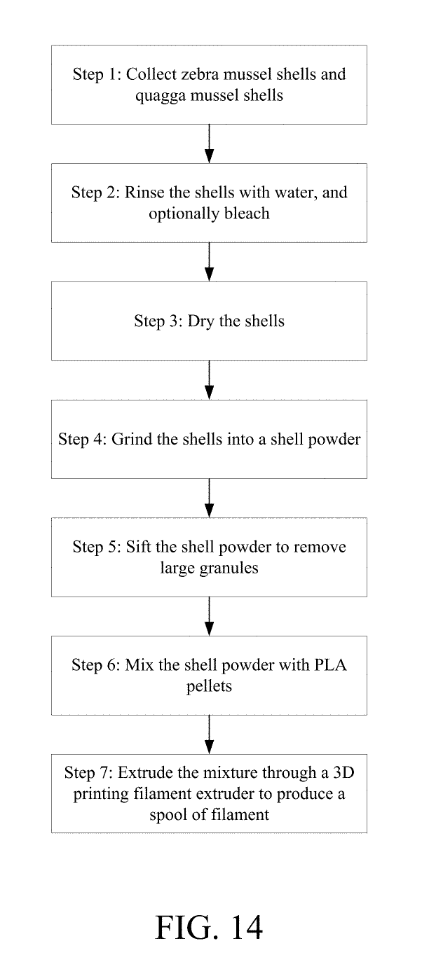

An exemplary method of producing a 3D printing filament with PLA and zebra mussel shell and quagga mussel shell powder, as shown in FIG. 14, includes the following steps. Each of the steps of the method may be performed as described herein. The methods also may include any other step(s) or variations of the disclosed step(s).

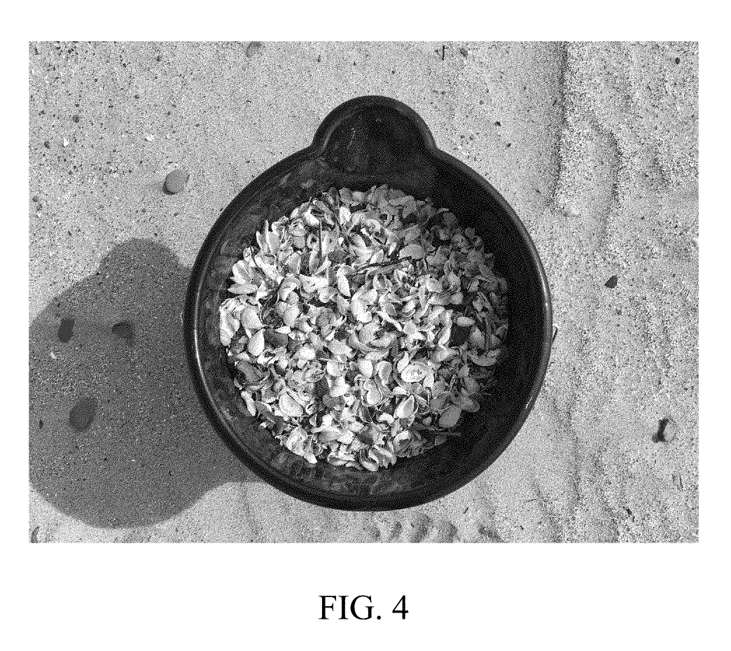

Step 1: Collect the shells. Zebra mussel shells and quagga mussel shells can be collected off of beaches, as shown in FIG. 4. Collection can be by hand or on a larger scale. For example, large volumes of beach sand can be screened through a filter to collect the shells. Other shells besides zebra mussel shells and quagga mussel shells may be removed because these other shells may have different levels of calcium carbonate. In this example, step 1 may take approximately 5 minutes per kg of shells.

Step 2: Rinse the shells with water and optionally with bleach mixture while sifting through them and removing rocks, drift wood, and other unwanted materials. This removal can be performed by hand or using a mechanical sorting system. The bleach mixture is merely one example of a chemical that can sanitize the shells. For example, this can kill bacteria such as E. coli. Generally, the mussel shells found on beaches do not contain the mussel organism. This sanitizing step is optional, but can make the handling process cleaner and/or less risky. In this example, step 2 may take approximately 15 minutes per kg of shells.

Cleaning the shells after collection can improve printing quality of the PLA coated with shell powder. Sand, dried algae, rocks, pebbles, plant life, non-zebra or quagga mussel shells, beach glass, drift wood, or other materials can be removed or rinsed away. A thorough cleaning process prior to pulverizing the shells can improve extrusion and printing qualities of the PLA coated with shell powder.

Step 3: Dry the shells. For example, the shells can be set outside on a towel or tray and dried with a blow dryer. The drying process also can be performed in an oven or using other techniques. It may be beneficial to completely dry the shell because any moisture may negatively affect the mixing and extruding processes. For example, moisture may result in sand clumping during mixing and bubbles in a filament during extrusion. In this example, step 3 may take approximately 10 minutes per kg of shells.

Step 4: Grind the shells. For example, a food processor and/or a mortar and pestle can be used to grind the shells to a flour consistency. Larger mechanical grinding systems also can be used. For example, the desired grain size of the powder may be less than or equal to 125 microns, though other values may be possible. In this example, step 4 may take approximately 10 minutes per kg of shells.

Step 5: Use a sifter to discard large granules. This may be a kitchen sifter, an industrial screen, or a mesh sieve. For example, particles with a grain size greater than or equal to 126 microns may be discarded, though other values may be possible. In this example, step 5 may take approximately 2 minutes per kg of shells.

Step 6: Mix the powder with PLA pellets. Powdered zebra mussel shell and powdered quagga mussel shell composite (e.g., approximately 125 micron grain size or smaller) can envelope PLA pellets in a fine layer of powder through any shaking method. It may be desired to shake surplus powder off of the pellets. The powder sticks to the PLA during shaking or mixing, though other additives can be used to enhance sticking. In an example, no more than 0.5 g of powder is added to 15 g of PLA. In this example, step 6 may take approximately 3 minutes per kg of shells.

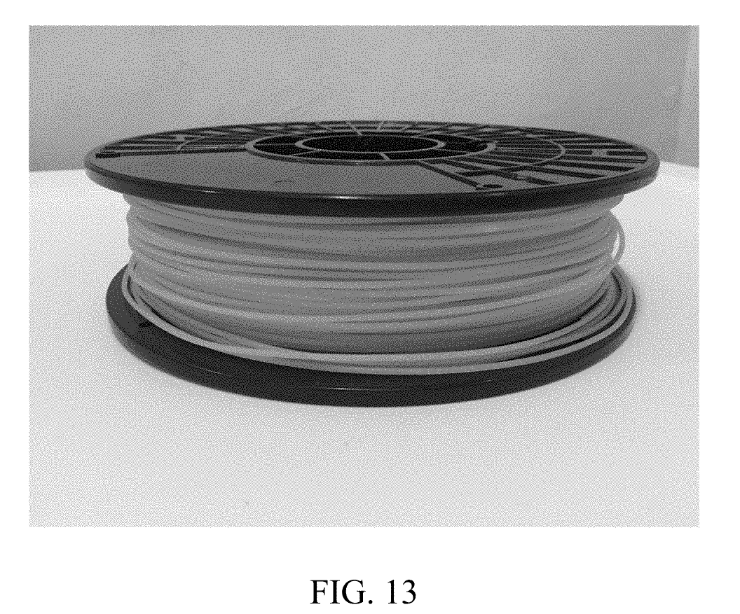

Step 7: The mixture of PLA pellets and zebra mussel shell powder and quagga mussel shell powder composite (e.g., at least 125 micron grain size) is extruded through a 3D printing filament extruder such as, but not limited to, the Filabot EX2 Filament Extruder. This may be performed at, for example, a temperature range from 155 degrees Celsius to 165 degrees Celsius (including all values to the 0.5 degree Celsius and ranges therebetween). Depending on the type of 3D printing filament extruder used, the ideal extrusion temperature range may vary as well as the extruded filament diameter. A completed spool of filament is shown in FIG. 13. Extruded filament can then be used for 3D printing in industries such as, but not limited to, architecture, consumer goods, technology, and commercial products. In this example, step 7 may take approximately 15 minutes per spool. Approximately four spools of filament may be created from 1 kg of shells.

### EXAMPLE 2

This example provides the effect of adding calcium carbonate to PLA.

An experiment was completed to determine the effect of adding calcium carbonate to PLA. Tools used in the experiment included a hot plate, PLA pellets, ground zebra and quagga mussel shells (CaCO₃), a scale, five beakers, a stirring rod, a shallow muffin pan, a temperature probe, and a small bowl. The control group for the experiment was 15 g PLA (without CaCO₃). The independent variable was the mass of CaCO₃ used in each test beaker. The dependent variables were the mass of PLA, the ambient temperature, and atmospheric pressure. The experimental method included the following steps. This experiment is meant to be illustrative. Variations are possible.

Step 1: Measure small bowl on scale.

Step 2: Zero scale.

Step 3: Measure 15 g of PLA pellets.

Step 4: Place 15 g of PLA pellets into beaker.

Step 5: Repeat steps 3-4 four times for a total of 5 beakers.

Step 6: Measure 1 g of CaCO₃.

Step 7: Mix CaCO₃ into a beaker of PLA.

Step 8: Measure 2 g of CaCO₃.

Step 9: Mix CaCO₃ into a beaker of PLA.

Step 10: Measure 3 g of CaCO₃.

Step 11: Mix CaCO₃ into a beaker of PLA.

Step 12: Measure 0.45 g (approximate value) of CaCO₃ (e.g., just enough to coat PLA).

Step 13: Mix CaCO₃ into a beaker of PLA (should now only have one beaker with pure PLA).

Step 14: Pour each beaker's contents into a section of the muffin pan.

Step 15: Heat to 250° C. on hot plate while stirring.

Step 16: Once mixture is completely melted, take off of hot plate and cool.

Step 17: Once cool, forcefully hit back of muffin pan until plastic disc pops out.

Step 18: Repeat steps 15-18 for the remaining beakers.

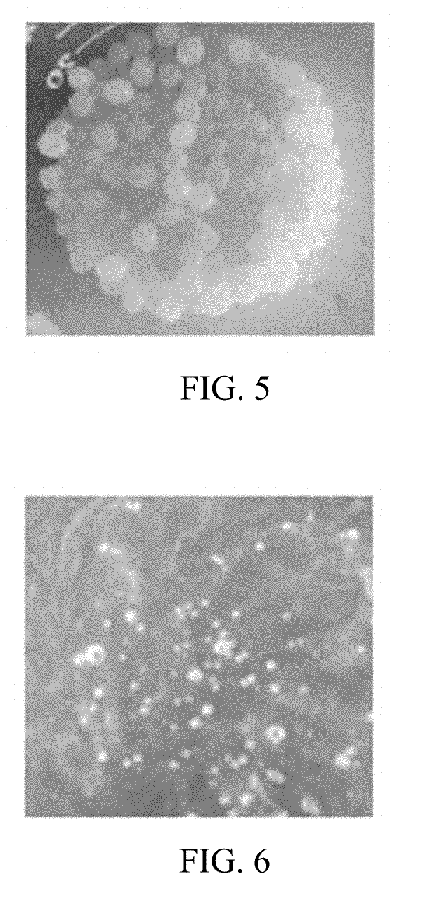

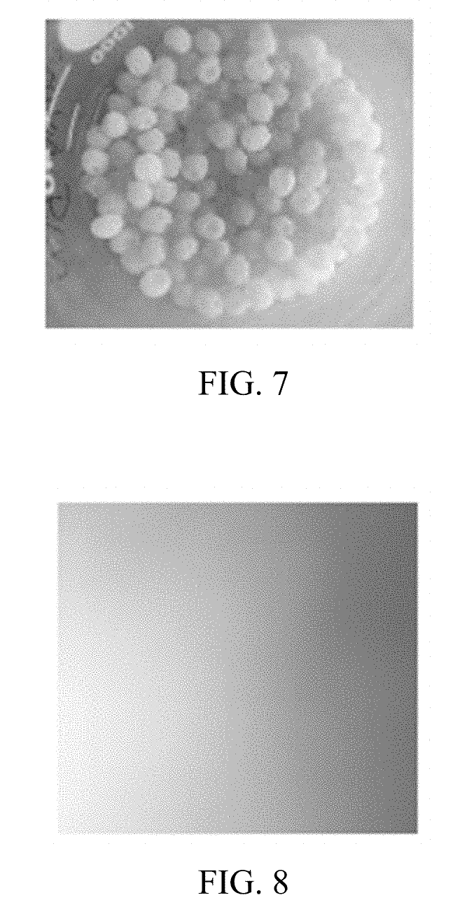

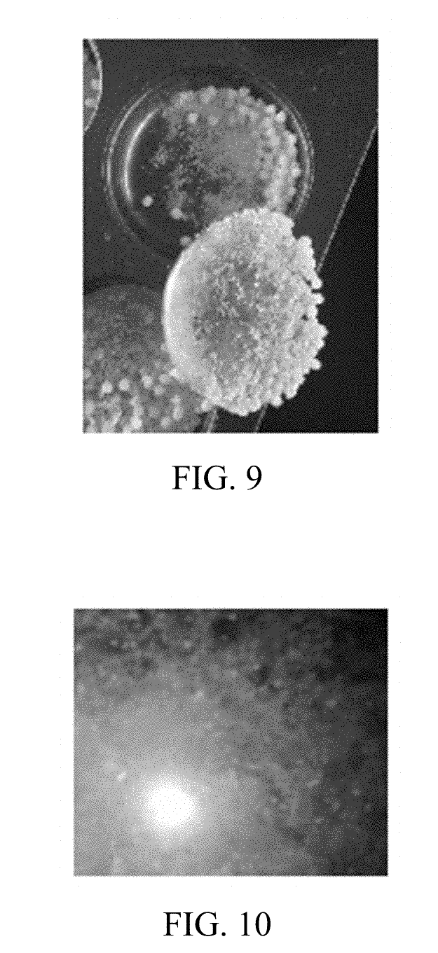

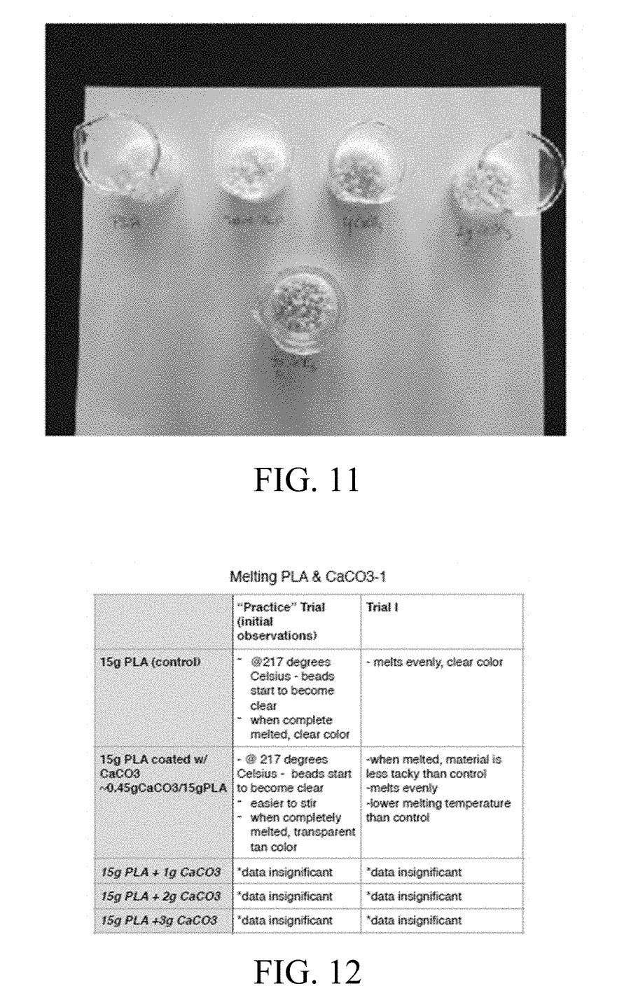

Images taken at various steps of the experiment are shown in FIGS. 5-11. The results of the experiment, shown in FIG. 12, yielded that PLA with more than 0.45 g of CaCO₃ per 15 g of PLA was grainy and unfavorable for 3D printing because the grains may clog the filament extruder and 3D printer. Thus, a ratio of less than 1 g of powder (e.g., calcium carbonate) per 15 g of PLA or less than 0.5 g of powder per every 15 grams of PLA may be used, though other ratios are possible. Even with a larger extruder, large grains may clog or damage a 3D printer.

### EXAMPLE 3

This example provides a description of using materials of the present disclosure.

Shell powder may be mixed with either pelleted or pulverized PLA. When mixing shell powder and PLA, the ratio of one part shell powder to three parts PLA may be used. Adding additional shell powder may hinder the filament extrusion process, but the ratio of 1 to 3 may be exceeded. The more shell powder added to the PLA mixture, the more opaque and rougher the extruded filament tends to be. In turn, rougher filament will induce more wear on the 3D printer used.

For example, using a ratio of one part powder to three part PLA results in a sandstone-like appearance when the 3D object is printed. The less powder used will decrease the sandstone-like appearance.

Printing the powder and PLA filament, the filament is treated as described in this disclosure and like other filaments known in the art. For example, the 3D printer is heated to a temperature of 180° C. and 200° C., including all 0.1° C. values and ranges therebetween. For example, the printer bed is heated to about 70° C.

### EXAMPLE 4

This example provides using PLA pellets coated with shell powder.

Although those having skill in the art can coat PLA pellets with shell powder, the present example describes mixing pulverized PLA having a micron size of 250 to 500 micron, including all micron values and ranges therebetween.

If PLA pellets are used, the ratio does not typically exceed one part powder to thirty-three parts PLA as to ensure a smooth filament extrusion process.

If pulverized PLA is used, the ratio does not typically exceed one part powder to three parts PLA as to ensure a smooth extrusion process.

### EXAMPLE 5

This example provides methods to qualify the opacity of materials of the present disclosure.

There are several variables that can be adjusted to affect the transparency of PLA. Independent variables include, but are not limited to: room temperature, pressure, humidity, and PLA size (e.g., diameter and thickness).

To qualify opacity, the following materials were used: a flashlight (i.e., a flashlight having at least 1000 lumens), a white sheet of paper with a large black X (e.g., having a font of at least 72) in the center, a PLA disk (i.e., a PLA disk comprising 15 g of melted PLA having a diameter of 3.5 inches and a 2 mm thickness), and a PLA and shell powder disc (i.e., a PLA and shell powder disc comprising 15 g of melted PLA and 5 g of shell powder, having a 3.5 inch diameter and 2 mm thickness).

To qualify opacity, the following steps were taken.
1) The white sheet having the black X was taped to a wall;
2) The flashlight was placed 15 feet from the paper and the black X was illuminated with the flashlight;
3) The “brightness” of the X was observed;
4) The PLA disk is placed in front of the flashlight and the “brightness” of the X was observed; and
5) The PLA and shell powder disk was placed in front of the flashlight, and the disc and light were moved towards the X until the X is as “bright” as it was when observed with just the PLA disc, and the distance was noted.

The independent variables described above were as follows.
1) Room temperature: 61° F.
2) Pressure: 1 atm; and
3) Humidity: 31%.

Using the method described above, and a PLA disk comprising 15 g of PLA and a PLA and shell powder disc comprising 15 g of PLA and 5 g of shell powder yielded the following results:

TABLE 1
Results of Opacity Test.

| | Distance from X needed for the X |
|---|---|
| | to be clearly illuminated |
| No disc | 15 feet |
| PLA disk | 15 feet |
| PLA and shell powder disk | 12 feet |

These data indicate shell powder increases the opacity of standard PLA.

### EXAMPLE 6

The example provides the results of a strength test of the materials of the present disclosure.

There are several variables that can be adjusted to affect the strength (e.g., tensile strength) of PLA. Independent variables include, but are not limited to: room temperature, pressure, humidity, and PLA size (e.g., diameter and thickness).

To quantify strength, the following materials were used: a C-clamp, weights (e.g., weights of various sizes, including a 2 lb. weight, a 5 lb. weight, a 10 lb. weight, and a 20 lb. weight); PLA filament (i.e., a 4 foot PLA filament), and a PLA and shell powder filament (i.e., a PLA and shell powder filament having a 3:1 ratio of PLA to shell powder).

The independent variables described above were as follows.
1) Room temperature: 61° F.
2) Pressure: 1 atm; and
3) Humidity: 31%.

To measure strength, the following steps were taken.
1) Both ends of the filament were clamped to a stable and sturdy surface, leaving the remainder hanging off the edge of the surface; and
2.) Weights were suspended (using the lowest weight weights first) until the filament breaks at the point of connection with the clamp and the edge of the surface top.

The method was repeated for both the PLA filament and the PLA and shell powder filament. The methods yielded the following results.

TABLE 2
Results of Strength Test.

| | Weight that broke the filament |
|---|---|
| PLA filament | 35 pounds |
| PLA and shell powder filament | 2 pounds |

These data indicate that PLA and shell powder filaments have a lower tensile strength than standard PLA filaments.

### EXAMPLE 7

This example provides the results of a temperature test of materials of the present disclosure.

There are several variables that can be adjusted to affect the melting point of PLA. Independent variables include, but are not limited to: room temperature, pressure, humidity, and PLA size (e.g., diameter and thickness).

To quantify the melting point, the following materials were used: a hot plate, pulverized PLA (i.e., pulverized PLA having a size of 250-500 micron), shell powder, twelve small heat resistant dishes, and a timer.

The independent variables described above were as follows. 0

1) Room temperature: 71° F.
2) Pressure: 1 atm; and
3) Humidity: 45%.

To measure the melting point, the following steps were taken.
1) The hot plate was heated to 300° C.;
2) 5 g of PLA was placed into the first small dish (ratio of 0:1);
3) 1.25 g of shell powder and 3.75 g of PLA power were mixed and placed into a second small dish (ratio of 1:3);
4) 1 g of shell powder and 4 g of PLA were mixed and placed into a third small dish (ratio of 1:4);
5) 0.83 g of shell powder and 4.17 g of PLA were mixed and placed into a fourth small dish (ratio of 1:5);
6) Each dish was heated while being timed, and the dish was removed from heating when the contents had completely melted, and the time was recorded; and
7) Each melt was repeated two more times.

The test yielded the following results:

TABLE 3
Melting test results.

| | First Dish | Second Dish | Third Dish | Fourth Dish |
|---|---|---|---|---|
| | (0:1) | (1:3) | (1:4) | (1:5) |
| Trial 1 | 14.08 minutes | 7.57 minutes | 8.53 minutes | 7.08 minutes |
| Trail 2 | 9.39 minutes | 6.55 minutes | 6.46 minutes | 9.08 minutes |
| Trial 3 | 10.45 minutes | 7.42 minutes | 9.36 minutes | 7.29 minutes |
| Average | 11.30 minutes | 7.18 minutes | 8.12 minutes | 7.80 minutes |

These data indicate that larger amounts of shell powder decrease the time it takes to melt the material.

### EXAMPLE 8

PLA coated with zebra mussel shell powder was run through a 3D printer. The temperature ranged from 155° C. to 165° C. The PLA material bubbled at 165° C.

A 1.75 mm non-melt filter nozzle was used with a Filabot EX2 extruder. The PLA material was extruded successfully. The nozzle may be selected to have a size larger than the particles used for printing.

Although the present disclosure has been described with respect to one or more particular embodiments and/or examples, it will be understood that other embodiments and/or examples of the present disclosure may be made without departing from the scope of the present disclosure.

1. A material for 3D printing, comprising CaCO₃ and polylactic acid, wherein the CaCO₃ is derived from crushed zebra mussel shells and/or crushed quagga mussel shells.

2. The material of claim 1, wherein the CaCO₃ and the polylactic acid are present in a ratio of 1:3 of CaCO₃ to polylactic acid.

3. The material of claim 1, wherein the CaCO₃ and the polylactic acid are present in a ratio of 1:4 of CaCO₃ to polylactic acid.

4. The material of claim 1, wherein the CaCO₃ and the polylactic acid are present in a ratio of 1:5 of CaCO₃ to polylactic acid.

5. The material of claim 1, wherein the CaCO₃ is primarily calcite.

6. The material of claim 5, wherein the CaCO₃ is only calcite.

7. The material of claim 1, wherein a grain size of the CaCO₃ is less than or equal to 125 microns.

8. The material of claim 7, wherein the grain size is less than or equal to 63 microns.

9. A method of preparing a 3D printing material, comprising:
i) combining calcium carbonate and polylactic acid to form a mixture, wherein the calcium carbonate is derived from crushed zebra mussel shells and/or crushed quagga mussel shells; and
ii) heating the mixture.

10. The method of claim 9, wherein the polylactic acid is a plurality of polylactic acid pellets.

11. The method of claim 9, wherein the calcium carbonate is less than or equal to 125 microns in grain size.

12. The method of claim 11, wherein the calcium carbonate is less than or equal to 63 microns in grain size.

13. The method of claim 9, wherein the mixture is heated to a temperature of 155 to 165° C.

14. The method of claim 9, further comprising passing the heated mixture through an extruder.

15. The method of claim 9, wherein the calcium carbonate and the polylactic acid are present in a ratio of 1:3 of calcium carbonate to polylactic acid.

16. The method of claim 9, wherein the calcium carbonate and the polylactic acid are present in a ratio of 1:4 of calcium carbonate to polylactic acid.

17. The method of claim 9, wherein the calcium carbonate and the polylactic acid are present in a ratio of 1:5 of calcium carbonate to polylactic acid.

18. The method of claim 9, wherein the calcium carbonate is primarily calcite.

19. The method of claim 18, wherein the calcium carbonate is only calcite.
